(19) United States
(12) Patent Application Publication
(10) Pub. No.: US 2023/0202384 A1
(43) Pub. Date: Jun. 29, 2023

(54) DEVICE FOR CONTROLLING AN AUXILIARY LIGHT MOUNTED TO A VEHICLE

(71) Applicant: ARB Corporation Limited, Kilsyth (AU)

(72) Inventors: Andrew Harry Brown, Kilsyth (AU); John Desmond CLARK, Kilsyth (AU); Simon John William STICKNEY, Kilsyth (AU)

(73) Assignee: ARB Corporation Limited, Kilsyth (AU)

(21) Appl. No.: 18/069,305

(22) Filed: Dec. 21, 2022

(30) Foreign Application Priority Data
Dec. 24, 2021 (AU) 2021904273

(51) Int. Cl. B60Q 1/14

(52) U.S. Cl. CPC B60Q 1/1461; B60Q 1/1423; B60Q 2300/05

(57) ABSTRACT

Control device for controlling an auxiliary light mounted to a vehicle having a first manually operable user input device (not shown) operable to cause generating a first signal and a second signal. The control device includes: at least two inputs including a first input configured to receive the first signal, and a second input configured to receive the second signal; an output configured to operably couple to the light to provide a control signal to cause the driving light to illuminate; and a logic circuit coupling each input to the output. The logic circuit includes a nonmechanical electronic switch operable to generate the control signal and provide the control signal to the output. The logic circuit operates the switch to generate the control signal responsive to the first input receiving the first signal, and the second input receiving the second signal.

### CROSS-REFERENCE TO RELATED APPLICATION(S)

This application claims priority to Australian patent application no. 2021904273, filed on Dec. 24, 2021, the entirety of which is incorporated by reference herein.

### TECHNICAL FIELD

The present disclosure relates generally to devices for controlling an auxiliary light mounted to a vehicle, such as a driving light or spot light.

### BACKGROUND

Auxiliary lights are mounted to vehicles to allow enhancing illumination provided by the vehicle’s factory-fitted lighting. For example, driving lights are usually arranged to complement the vehicle’s headlamps and operated to enhance a driver’s vision when driving off-road, or in otherwise unlit environments, at night. One or more driving lights are typically retrofitted to a vehicle, being mounted on the front bumper and/or the roof, or a roof-mounted cargo system such as a roof bar, tray or platform. Various other auxiliary lights may be fitted to a vehicle, such as spot lights to illuminate in front of, or to the side of, the vehicle, light bars to illuminate the front, sides and/or underneath of the vehicle, and reversing lamps to illuminate to the rear of the vehicle.

It is often desirable, and can be a legal requirement, to integrate the operation of driving lights with the operational modes of a vehicle’s headlamps. Headlamps are generally operable in “low (dipped) beam” or “high beam” modes, as well as “parking” or “side lights” in some vehicles. Low beam mode directs light emitted from the headlamps downwardly, towards the road, whereas high beam mode directs the light directly forward. Headlamps are typically only operated by a driver in high beam mode when there are no oncoming vehicles to avoid blinding the driver of an oncoming vehicle, which could cause an accident. For the same reason, a driving light should only be able to be operated when the driver has intentionally selected high beam mode. However, integrating operation of a driving light with the headlamps of a modern vehicle can be complex, particularly when the vehicle includes a controller area network (CAN) bus arranged to interconnect devices in the vehicle, including the headlamps, and electronic control units (ECUs) to effect control of the devices.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

In an aspect of the present disclosure, there is provided a control device for controlling an auxiliary light mounted to a vehicle, the vehicle having a first manually operable user input device operable to cause generating a first signal and a second signal, the control device including: at least two inputs, a first input configured to receive the first signal, and a second input configured to receive the second signal; an output configured to operably couple to the auxiliary light to provide a control signal to cause the auxiliary light to illuminate; and a logic circuit coupling each input to the output and including a non-mechanical electronic switch operable to generate the control signal and provide the control signal to the output, the logic circuit configured to operate the non-mechanical electronic switch to generate the control signal responsive to: the first input receiving the first signal, and the second input receiving the second signal.

Each of the first input and the second input may be configured to receive a high voltage signal or a low voltage signal from the vehicle, and the logic circuit may be configured such that the control signal is generated responsive to each of the first signal and the second signal being low voltage signals. The logic circuit may be configured such that the control signal is a low voltage signal. The first signal may comprise less than approximately 4 volts, and the second signal may comprise less than approximately 4 volts, and the first input may be configured to receive the voltage of the first signal, and the second input may be configured to receive the voltage of the second signal.

The vehicle may include a second manually operable user input device operable to cause generating a third signal, and the control device may include a third input configured to receive the third signal, and the logic circuit may be configured to operate the non-mechanical electronic switch to provide the control signal to the output responsive to: the first input receiving the first signal, the second input receiving the second signal, and the third input receiving the third signal. The second manually operable user input device may be configured as an automatic high beam (AHB) mode switch, wherein operating the switch causes generating the third signal as an AHB off signal, and the third input may be configured to receive the AHB off signal. Each of the first input, the second input, and the third input may be configured to receive a high voltage signal or a low voltage signal from the vehicle, and the logic circuit may be configured such that the control signal is generated responsive to each of the first signal and the second signal being low voltage signals and the third signal being a high voltage signal. The third signal may comprise between approximately 5 and 12 volts, and the third input may be configured to receive the voltage of the third signal.

The logic circuit may include at least one logic gate, the, or each, logic gate being associated with at least two of the inputs. The logic circuit may include at least two logic gates, and one of the logic gates may be associated with one of the inputs and an output of another logic gate.

The logic circuit may include a microcontroller, the microcontroller configured to operate the non-mechanical electronic switch responsive to receiving the first signal and the second signal. The non-mechanical electronic switch may include a metal-oxide-semiconductor field-effect transistor.

The device may further comprise a power input. The vehicle may comprise an accessories circuit, and the power input may be connectable to the accessories circuit. The power input may be configured to receive a 12-volt signal.

The control signal generated by the non-mechanical electronic switch may power the auxiliary light. The vehicle may comprise headlamps operable to illuminate in a headlamp on mode and a high beam mode, and the first manually operable user input device may be configured as a headlamp stalk for controlling operation of the headlamps, wherein operating the stalk causes generating the first signal as a headlamp on signal, and generating the second signal as a high beam on signal, and the first input may be configured to receive the headlamp on signal, and the second input may be configured to receive the high beam on signal.

The auxiliary light may comprise a driving light mounted to the vehicle, and the output may be configured to operably couple to the driving light to provide the control signal and cause the driving light to illuminate.

In another aspect of the present disclosure, there is provided a vehicle including the device described above.

In another aspect of the present disclosure, there is provided a kit comprising an auxiliary light and the device described above.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure will now be described by way of example only with reference to the accompanying drawings in which:

FIG. 1 shows a perspective view of a vehicle having headlamps and a plurality of driving lights mounted to the roof and front bumper of the vehicle;

FIG. 2 shows a schematic of an embodiment of a device for controlling a driving light mounted to a vehicle, in use;

FIG. 3 shows a schematic of an embodiment of the layout of the device shown in FIG. 2;

FIG. 4 shows a circuit diagram of an embodiment of a logic circuit of the device shown in FIG. 2;

FIG. 5 shows a schematic of another embodiment of a device for controlling a driving light mounted to a vehicle, in use;

FIG. 6 shows a schematic of an embodiment of the layout of the device shown in FIG. 5;

FIG. 7 shows a circuit diagram of an embodiment of a logic circuit of the device shown in FIG. 5;

FIG. 8 shows a schematic of another embodiment of the layout of the device shown in FIG. 5; and

FIG. 9 shows a circuit diagram of another embodiment of the logic circuit of the device shown in FIG. 5.

### DESCRIPTION OF EMBODIMENTS

In the drawings, reference numeral 10 generally designates a control device 10 for controlling an auxiliary light, in the illustrated embodiments being in the form of a driving light 12, mounted to a vehicle 14. The vehicle 14 has a first manually operable user input device (not shown) operable to cause generating a first signal and a second signal. In the illustrated embodiments, the vehicle 14 includes headlamps 16 and the first manually operable user input device is configured as a headlamp stalk (not shown) for controlling operation of the headlamps 16. The stalk is operable by the driver of the vehicle to cause generating the first and second signals. In this configuration, the first signal is a headlamp on signal 18 and the second signal is a high beam on signal 20 (FIG. 2).

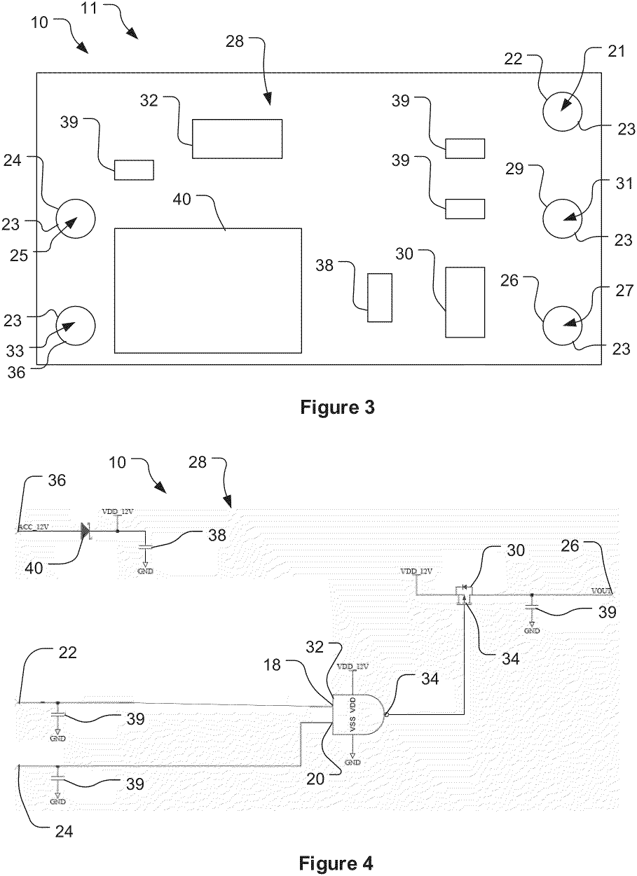

The control device 10 includes at least two inputs 22, 24 (FIG. 4), including a first input 22 configured to receive the first signal, and a second input 24 configured to receive the second signal. The device 10 also includes an output 26 (FIG. 3) configured to operably couple to the driving light 12 to provide a control signal to cause the driving light 12 to illuminate, and a logic circuit 28 (FIG. 3) coupling each input 22, 24 to the output 26. The logic circuit 28 includes a non-mechanical electronic switch, in the illustrated embodiments in the form of a transistor 30, operable to generate the control signal and provide the control signal to the output 26. The logic circuit 28 is configured to operate the transistor 30 to generate the control signal responsive to: the first input 22 receiving the headlamp on signal 18, and the second input 24 receiving the high beam on signal 20.

It will be understood that whilst the control device 10 is described below with reference to headlamps 16, a headlamp stalk and a driving light 12, the device 10 is readily configurable to control operation of other auxiliary lights based on signals generated by operation of other manually operable user input devices associated with the vehicle 14. Suitable user input devices may include an accelerator pedal, a brake pedal, a handbrake lever, a transmission shifter, an indicator stalk, a windscreen wiper stalk, switches, dials, and the like.

In the illustrated embodiments, the device 10 includes a printed circuit board (PCB) 11 carrying and interconnecting components, including the transistor 30. The transistor 30 is in the form of a metal-oxide-semiconductor field-effect transistor (MOSFET), for example, a P-Channel MOSFET. However, it will be appreciated that the device 10 is not limited to being PCB-based and that the MOSFET may be substituted with any suitable transistor. It will also be understood that the transistor 30 is one example embodiment of the non-mechanical electronic switch described above, and that other such switches are within the scope of this disclosure. For example, this may include one or more of a transistor bipolar junction, an optical isolator, and an IC microcontroller. It will be appreciated that non-mechanical electronic switches refer to any electronic switch which does not include mechanical components. This arrangement avoids moving parts which can prove unreliable, particularly when the device 10 is fitted to a vehicle intended for off-road driving where the device 10 is likely to be subject to vibrations and/or adverse environmental conditions, such as extremes of temperature, humidity, and/or dust ingress.

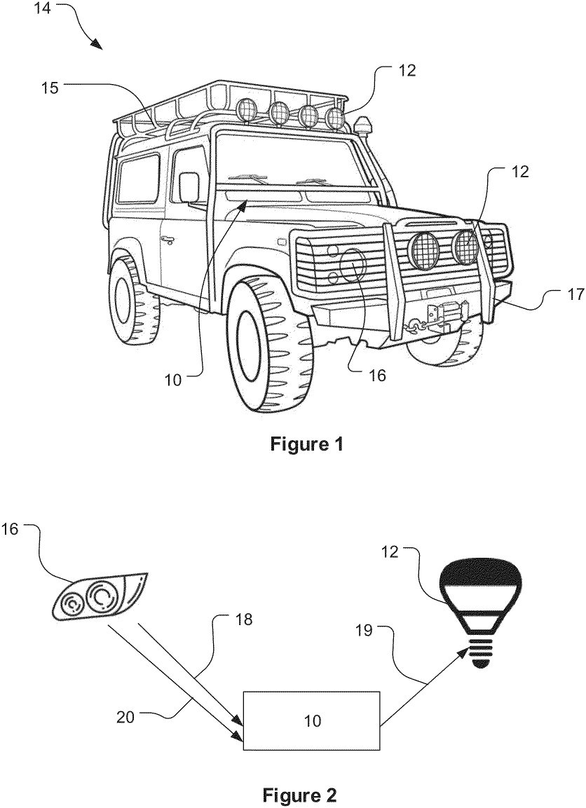

FIG. 1 shows an example embodiment of the vehicle 14 in the form of a sport utility vehicle (SUV). The vehicle 14 includes a pair of spaced headlamps 16 and a plurality of driving lights 12 mounted to a roof 15 and front bumper 17 of the vehicle 14. The vehicle 14 also includes a CAN bus (not shown) arranged to connect the headlamps 16 to other systems or devices in the vehicle 14, including a headlamp stalk (not shown), being a user input device arranged adjacent the steering wheel (not shown). The headlamp stalk includes a switch (not shown) and a mode selector (not shown), these components operable by one or more of pivoting the stalk about one or two axes relative to the steering wheel, and rotating a dial at a free end of the stalk. A driver of the vehicle 14 can manually operate the headlamp stalk to operate the switch, such as twisting a dial mounted to the stalk, or twisting the stalk itself, to cause the headlamp on signal 18 to be conveyed through a controller connected with the CAN bus. The driver may also operate the stalk to adjust headlamp mode, such as pivoting the stalk towards or away from the driver, to cause the high beam on signal 20 to be conveyed through the controller connected with the CAN bus.

The device 10 is configured to be mounted in the cabin of the vehicle 14, typically behind the dashboard. The device 10 is operably coupled to the headlamp stalk to allow receiving the headlamp on signal 18 and the high beam on signal 20, typically by splicing into wires integrated in the vehicle 14 which carry these signals from the stalk to the controller. Arranging the device 10 in this way allows receiving the signals 18, 20 without requiring interaction with the CAN bus, which could require complex electronic components, such as a microprocessor, consequently allowing bypassing the CAN bus to control operation of the auxiliary light 12. The headlamp stalk is also operable to deliver other signals, such as a headlamp off signal, a high beam off signal, a parker light on signal, and a low beam on signal.

The device 10 is typically operably coupled to one or more of the driving lights 12 indirectly via, for example, a cable harness (not shown) arranged between the device 10 and the light(s) 12, to allow providing the control signal. In some embodiments (not illustrated), other intermediary electronic components may be arranged between the device 10 and the light(s) 12, such as a programmable logic controller (PLC), computer controller (IC), and the like. Typically, the cable harness is configured such that, responsive to receiving the control signal from the output 26 of the device 10, power is supplied to the one or more of the driving lights 12 to cause illumination.

Typically, the device 10 is configured such that the control signal comprises insufficient power and/or current to cause operation of the auxiliary light and instead acts as a trigger to cause sufficient power to be supplied to the operate the light. In some embodiments, the device 10 is configured such that the control signal generated by the transistor 30 directly powers one or more of the driving lights 12. In such embodiments, the device 10 may be directly connected to the one or more of the driving lights 12 via wires being fed into the vehicle 14 from the lights 12.

FIG. 2 shows a schematic of a first embodiment 100 of the device 10. The schematic illustrates the headlamp on signal 18 and/or the high beam on signal 20 being received by the device 10 responsive to the driver operating the headlamp stalk, and consequently operating the headlamp 16. The schematic shows the device 10 transmitting the control signal 19 to the driving light 12 as an output in response to receiving the input conditions described above and in greater detail below.

FIGS. 3 and 4 illustrate the layout of the PCB 11 of the first embodiment 100, and a circuit diagram illustrating the logic circuit 28 of the PCB 11 of the first embodiment 100, respectively. The traces of the PCB layout are hidden in FIG. 3 to enhance clarity of this drawing.

This embodiment 100 includes a pair of inputs 22, 24, each including a hole 21, 25 defined in the PCB 11, and an electrical contact 23 arranged about each of the holes 21, 25. The inputs 22, 24 are configured to receive and electrically couple to wires (not shown) connected to the vehicle 14 to receive the headlamp on signal 18 and the high beam on signal 20. The output 26 includes a hole 27 defined in the PCB 11 and an associated electrical contact 23 to allow receiving and coupling to a wire connected to the driving light 12. The PCB 11 also includes a ground connector 29, in the form of a third hole 31, and an associated electrical contact 23, configured to connect to the vehicle’s ground. The PCB 11 is typically configured such that the wires are soldered directly to the holes 21, 25, 27, 31 to form an electrical contact between the wires and the PCB 11. It will be appreciated that this arrangement is exemplary and that other electrical coupling configurations, such as including alternative connectors, are within the scope of this disclosure.

The logic circuit 28 includes a single logic gate 32 which is associated with the inputs 22, 24 to allow receiving the headlamp on signal 18 and the high beam on signal 20 as inputs to the logic gate 32. The headlamp on signal 18 is generated when the driver of the vehicle 14 manually operates the stalk to switch the headlamps 16 on, causing the stalk to transmit the signal to the controller connected to the CAN bus of the vehicle 14. The high beam on signal 20 is generated and transmitted when the driver operates the stalk to activate high beam operation. Similarly, when the headlamps 16 are switched off (again by the driver operating the stalk), a headlamp off signal is generated and transmitted, and when the high beam mode is deactivated (by the driver operating the stalk), a high beam off signal is generated.

Typically the headlamp on signal 19 and high beam on signal 20 comprise a voltage which is less than the counterpart headlamp off signal and high beam off signal. For example, a voltage of the headlamp on signal 18 and the high beam on signal 20 typically comprises less than approximately 4 volts, and a voltage of the headlamp off signal and the high beam off signal comprises greater than approximately 4 volts. In some embodiments, the voltage of the headlamp on signal 18 and the high beam on signal 20 comprises approximately 0 volts, and a voltage of the headlamp off signal and the high beam off signal comprises greater than approximately 4 volts. Thus, the headlamp on signal 18 and the high beam on signal 20 represent low voltages compared to the headlamp off signal and the high beam off signal, respectively.

In some vehicles, this configuration is reversed, i.e. the headlamp on signal 18 and the high beam on signal 20 represent high voltages compared to the headlamp off signal and the high beam off signal, respectively. Furthermore, in some vehicles the headlamp on signal 18 may represent a high voltage and the high beam on signal 20 may represent a low voltage, or vice versa. In many vehicles, the difference in voltage between each of the headlamp on signal 18 and the high beam on signal 20 and its associated off signal is at least approximately 1 volt. It will be appreciated that the device 10 is configurable to suit the configuration of the first and second signals generated by the vehicle 14.

In some vehicles 14, the headlamp on signal 18 comprises 0 volts and the headlamp off signal comprises 10 volts, and the high beam on signal 20 comprises 0 volts and the high beam off signal comprises 5 volts. Thus, when the headlamps 16 are non-operational, a 10-volt and a 5-volt signal is received by the inputs 22, 24, respectively. In the illustrated embodiment 100, the logic gate 32 is a NAND gate which is configured to output 34 a low voltage signal, or a “low”, when the headlamp on signal 18 and the high beam on signal 20 are both low, for example, are both 0 volts. The output 34 of the logic gate 32 is connected to the transistor 30, and the transistor 30 is configured to only provide the control signal 19 to the driving light 12, via the PCB output 26, when the logic gate output 34 is “low”. In addition to, or instead of, the logic gate 32, the logic circuit 28 is configurable to include a microcontroller (not shown) configured to operate the transistor 30 responsive to receiving the headlamp on signal 18 and the high beam on signal 20. It will be appreciated that in other embodiments, the headlamp on signal 18 and the high beam on signal 20 may both be “high” signals, and that the logic gate 32 and the transistor 30 may be alternatively configured such that the output 34 of the logic gate 32 is a high signal, which would allow the transistor 30 to provide the control signal 19 to the driving light 12.

To power the components of the device 10, the PCB 11 includes a power input 36 which is configured to receive a 12-volt signal. The 12-volt signal is received from a power-carrying wire connected to the accessories circuit (not shown) of the vehicle 14. The power input 36 includes a further hole 33 defined in the PCB 11 and associated with a contact 23 to allow receiving the power-carrying wire of the accessories circuit. The PCB 11 is configured such that the power-carrying wire is fed through the hole 33 to be soldered to the power input 36 to power the logic circuit 28, including the logic gate 32 and the transistor 30. It will be understood that power may be provided via an alternative means, such as a direct connection to a battery carried by the vehicle 14.

The logic circuit 28 also includes capacitors 38, 39 connected to the power input 36, and to the inputs 22, 24 and output 26, respectively. The capacitor 38 is arranged to act as a smoothing capacitor to moderate fluctuations in voltage supplied to the logic gate 32 from the power input 36. In this embodiment 100, the capacitor 38 has a capacitance of around 1 microfarad. The capacitors 39 connected to the inputs 22, 24 and output 26 are arranged to reduce electromagnetic interference and filter out high voltages supplied to the logic gate 32 from the wires carrying the headlamp on signal 18 and high beam on signal 20. In this embodiment 100, each capacitor 39 has a capacitance of around 100 nanofarads. The logic circuit 28 also includes a diode 40 to protect the logic gate 32 from reverse polarity. It will be appreciated that the capacitors 38, 39 and/or diode 40 may be provided in a different configuration and/or with different capacitances.

The logic circuit 28 of embodiment 100 is configured to provide the control signal 19, via the output 26, responsive to the logic gate 32 receiving the headlamp on signal 18 from the first input 22 and the high beam on signal 20 from the second input 24. The function of the logic circuit 28 is summarised in the logic table below, where values of 0 indicate “OFF” and values of 1 indicate “ON”. The table shows that there is only one set of input conditions which cause the control signal 19 to be generated, consequently causing power to be supplied to the driving light 12 to operate and illuminate the light 12. It will be understood that in other embodiments, the control signal 19 may be alternatively or additionally generated responsive to the high beam on signal 20 being received by the second input 24 and the headlamp off signal being received by the first input 22. It will also be understood that the auxiliary light may be directly connected to the output 26 and that control signal generated by the non-mechanical electronic switch may directly power the auxiliary light, for example, by providing a control signal with a suitable voltage and current to the directly connected auxiliary light.

TABLE 1

Logic table of the first embodiment 100 of the device 10

| Headlamp Signal | High Beam Signal | Logic Circuit Output |
|---|---|---|
| 0 | 0 | 0 |
| 0 | 1 | 0 |
| 1 | 0 | 0 |
| 1 | 1 | 1 |

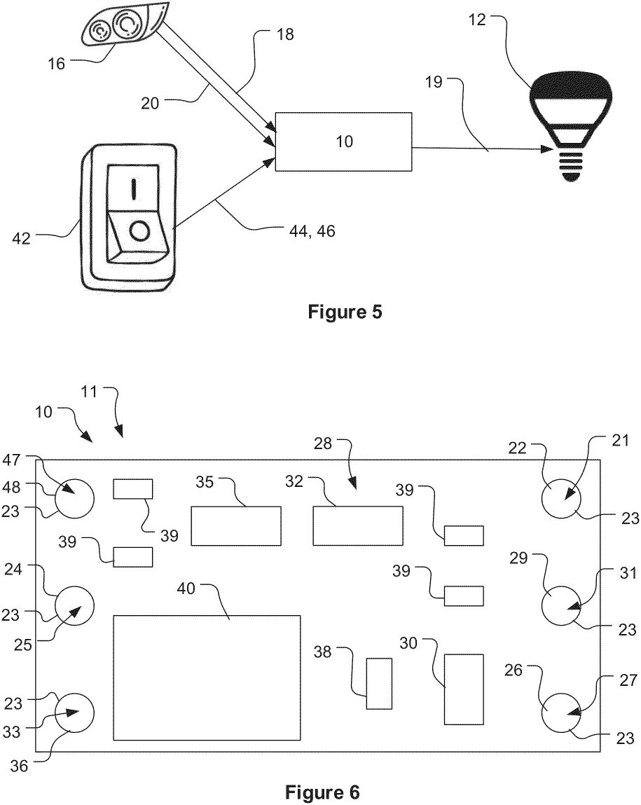

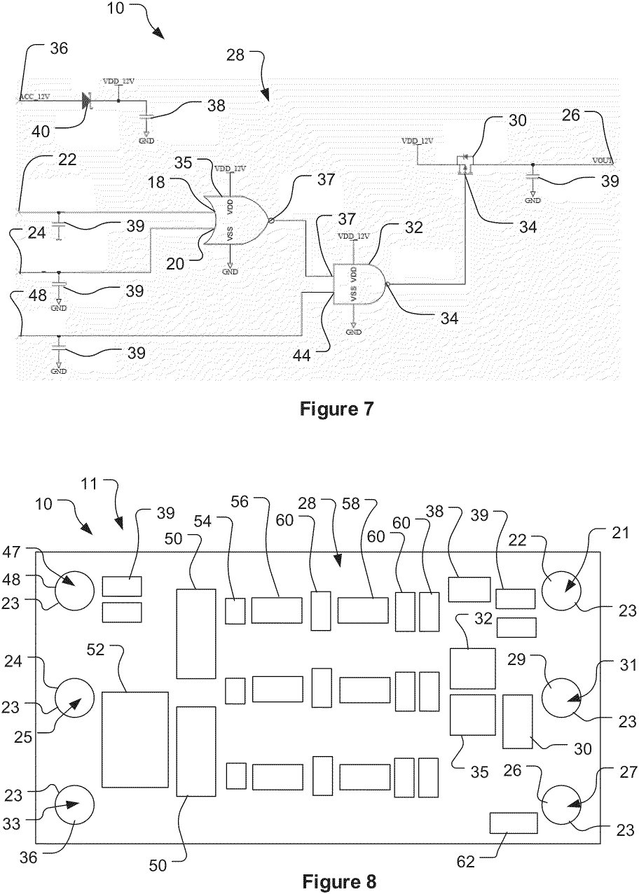

A second embodiment 200 of the device 10 is shown in FIGS. 5 to 7. The second embodiment 200 shares features with the first embodiment 100, and it will be appreciated that common reference numerals indicate common features. FIG. 5 is a schematic of the second embodiment 200, FIG. 6 shows the layout of the PCB 11 of this embodiment 200, and FIG. 7 illustrates the logic circuit 28 of this embodiment 200. The traces of the PCB layout are not shown in FIG. 6 for clarity.

The second embodiment 200 of the device 10 is configured to integrate with vehicles having a second manually operable user input device, such as switch (not shown) operable to activate or deactivate automatic high beam (AHB) functionality. The vehicle 14 is configured in this way so that when the driver operates the switch, the headlamps 16 are automatically adjusted between low beam mode and high beam mode. This is typically in response to sensors (not shown) mounted to the vehicle 14 sense the presence of approaching objects, such as other vehicles. The switch 42 is illustrated in FIG. 5. Operating the switch 42 causes generating third and fourth signals, in this embodiment being an AHB off signal 44 and an AHB on signal 46, respectively.

FIG. 5 shows a schematic of the second embodiment 200 of the device 10. The schematic illustrates the headlamp on signal 18 and/or the high beam on signal 20 being received by the device 10 responsive to the driver operating the headlamp stalk, and consequently operating the headlamp 16. The schematic also shows the switch 42 transmitting the AHB off signal 44 or the AHB on signal 46 to the device 10, as well as the device 10 transmitting the control signal 19 to the driving light 12 as an output responsive to the input conditions described below.

Referring to FIGS. 6 and 7, the PCB 11 of this embodiment 200 includes a third input 48, with an associated capacitor 39, configured to connect to a wire connected to the vehicle 14 to receive the AHB off signal 44 and AHB on signal 46. The logic circuit 28 is configured to operate the transistor 30 to provide the control signal 19 to the output 26 responsive to: the first input 22 receiving the headlamp on signal 18, the second input 24 receiving the high beam on signal 20, and the third input 48 receiving the AHB off signal 44. In this embodiment, the voltages of the AHB off signal 44 and the AHB on signal 46 differ by at least approximately 1 volt. In some embodiments, the AHB off signal 44 comprises between approximately 5 and 12 volts and the AHB on signal comprises between approximately 0 and 4 volts, or vice versa. Typically, the AHB off signal 44 comprises 10 volts (high), and the AHB on signal 46 comprises 0.7 volts (low).

Shown in FIG. 6, the third input 48 includes a hole 47 defined in the PCB 11 and an associated electrical contact 23 to allow receiving and coupling to a switch wire (not shown). Shown in FIG. 7, in this embodiment 200 the logic circuit 28 includes two logic gates 32, 35 to allow receiving the required input conditions. In this embodiment 200, the headlamp on signal 18 and the high beam on signal 20 are connected to a NOR gate 35, and the output 37 of the NOR gate 35, as well as the third input 48, are inputs to the NAND gate 32. The output 34 of the NAND gate 32 is connected to the transistor 30. Therefore, the NOR gate 35 is associated with the first and second inputs 22, 24, and the NAND gate 32 is associated with the third input 48 and the output 37 of the NOR gate 35 in this embodiment 200.

The NOR gate 35 is configured to output a “high” when both the headlamp on signal 18 and the high beam signal 20 both are low, i.e. the headlamp 16 is on and in high beam mode. The NAND gate 32 is configured to output a “low” when receiving two “high” signals, being the NOR gate output 37 and the third input 48 receiving the AHB off signal 44. The transistor 30 is configured to only provide the control signal 19 to the driving light 12 via the output 26 when the NAND gate output 34 is “low”. The configuration of this embodiment 200 is summarised in the logic table below, where values of 0 indicate “OFF” and values of 1 indicate “ON”, and which shows that there is only one set of input conditions which cause generating the control signal 19 which consequently causes power to be supplied to the driving light 12 and cause illumination of the light 12. It will be understood that in other embodiments, the control signal 19 may be alternatively or additionally be generated responsive to the high beam on signal 20 being received by the second input 24, the headlamp on signal 18 being received by the first input 22, and the AHB off signal 44 being received by the third input 48.

TABLE 2

Logic table of the second embodiment 200 of the device 10

| Headlamp Signal | High Beam Signal | Automatic High Beam Switch Signal | Logic Circuit Output |
|---|---|---|---|
| 0 | 0 | 0 | 0 |
| 0 | 0 | 1 | 0 |
| 0 | 1 | 0 | 0 |
| 0 | 1 | 1 | 0 |
| 1 | 0 | 0 | 0 |
| 1 | 0 | 1 | 0 |
| 1 | 1 | 0 | 1 |
| 1 | 1 | 1 | 0 |

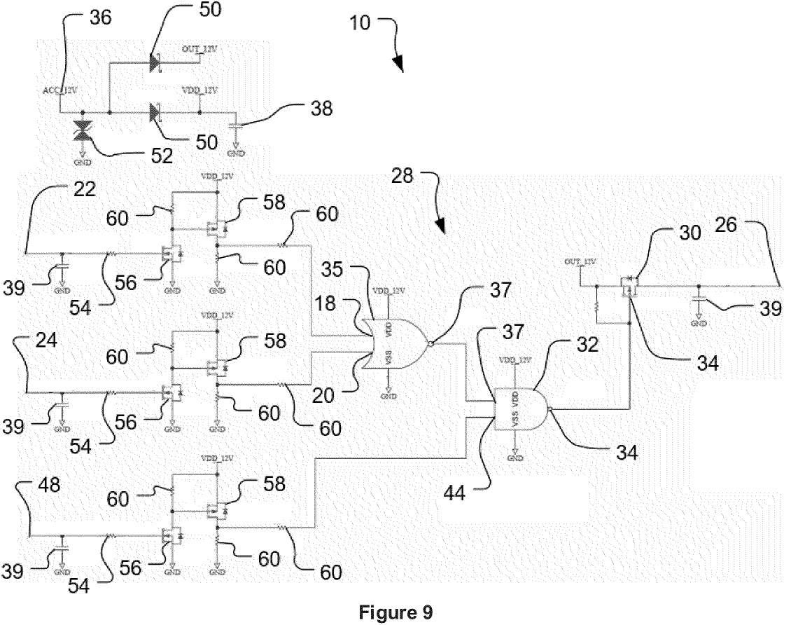

A third embodiment 300 of the device 10 is shown in FIGS. 8 and 9. The third embodiment 300 shares features with the second embodiment 200, and it will be appreciated that common reference numerals indicate common features. FIG. 8 shows the layout of the PCB 11 of this embodiment 300 and FIG. 9 illustrates the logic circuit 28 of this embodiment 300. The traces of the PCB layout are not shown in FIG. 8 for clarity and components of the PCB layout in FIG. 8 of the same size and orientation are considered like components.

Referring to FIGS. 8 and 9, the PCB 11 and the logic circuit 28 of this embodiment 300 includes blocker diodes 50 connected to the power input 36 for isolating both the output 26 and a voltage supply to the logic gates 32, 35 from the power input 36, and a transient voltage suppressor 52 connected to the power input 36 to protect the logic circuit 28 from power surges originating from the vehicle 14. This embodiment 300 also includes current limiters 54, each of around 1,000 ohms, connected to the first, second and third inputs 22, 24, 48 to protect a circuit (not shown) of the vehicle 14 from an initial current surge when a voltage is applied to the gates 32, 35. An N-Channel MOSFET 56, a P-Channel MOSFET 58, and resistors 60, each of around 10,000 ohms, are also connected to the first, second and third inputs 22, 24, 48, which, together, act as a switching circuit to isolate the inputs 22, 24, 48 and to inhibit voltage being fed to the logic gates 32, 35 when VDD is off. A gate pull-up resistor 62 of around 10,000 ohms is connected to the transistor 30 to inhibit the transistor 30 from turning on unintentionally. The configuration of this embodiment 300 is in accordance with Table 2 above.

To allow using the device 10 to control operation of the driving lights 12 mounted to the vehicle 14, the device 10 is installed in the vehicle 14 by, for example, mounting the device 10 behind the vehicle’s dashboard. Wires are spliced into the vehicle wires leading from the headlamp stalk to a controller connected to the CAN bus and arranged in, and coupled to, such as by soldering, the holes 21, 25 of the first and second inputs 22, 24 of the device 10 to allow conveying the headlamp on signal 18, and high beam on signal 20, to the device 10. A grounding wire connected to the vehicle’s ground, and a harness connected to the driving light 12, are coupled to the ground connection 29 and the output 26 of the device 10, respectively, such as by feeding the wires behind the dashboard and soldering to the PCB 11. Where the vehicle 14 includes the automatic high beam switch 42, a wire is spliced into the vehicle wire configured to convey the AHB on/off signals 44, 46, and the wire is arranged in, and coupled to, the hole 47 of the third input 48. A power-carrying wire connected to the accessories circuit of the vehicle 14 is coupled to the power input 36.

Once the device 10 has been installed in the vehicle 14, when the user turns on the headlamps 16 by operating the headlamp stalk, and sets the headlamps 16 to high beam mode, the headlamp on signal 18 and high beam on signal 20 is received by the device, causing operation of the transistor 30 to supply the control signal 19 to the driving light 12, consequently causing the driving light 12 to illuminate.

The device 10 is configured to restrict operation of the driving light 12 to when the headlamps 16 are on and in high beam mode. This can usefully limit instances of operation of the driving light which could affect vision of other drivers. Inhibiting the user from operating the driving light 12 without the use of the headlamps 16 can also ensure that the user adheres to the law applicable in some jurisdictions. Further, the use of a non-mechanical electronic switch, such as the transistor 30, allows for the device 10 to be configured as a compact package with minimal or no moving parts, which can advantageously reduce complexity and enhance reliability. The device 10 is configured to bypass the CAN bus of the vehicle 14, such as by receiving the first and second signals before these signals reach the vehicle’s CAN bus, and to transmit the control signal 19 for powering the driving light 12 without using of the vehicle’s CAN bus. This simplifies construction, installation and operation of the device 10.

The embodiment 200 of the device 10 including the third input 48 allows users with vehicles 14 having the automatic high beam switch 42 to appropriately control operation of the driving light 12. The embodiment 200 of the device 10 is configured to require the automatic high beam switch 42 to be turned off to allow providing the control signal 19 to the driving light 12. This prevents instances of the automatic high beam functionality operating the headlamps 16 in high beam mode, causing operation of the driving light 12 which in turn produces sufficient light to cause deactivation of the high beam mode, which can result in a looped sequence resulting in the driving light 12 emitting pulsed light.

It will be appreciated that a vehicle may be provided which includes the device 10 as an integrated component or as part of a sub-system. It will also be appreciated that a kit may be provided which includes the driving light 12 and the device 10.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A control device for controlling an auxiliary light mounted to a vehicle, the vehicle having a first manually operable user input device operable to cause generating a first signal and a second signal, the control device including:
at least two inputs, a first input configured to receive the first signal, and a second input configured to receive the second signal;
an output configured to operably couple to the auxiliary light to provide a control signal to cause the auxiliary light to illuminate; and
a logic circuit coupling each input to the output and including a non-mechanical electronic switch operable to generate the control signal and provide the control signal to the output, the logic circuit configured to operate the non-mechanical electronic switch to generate the control signal responsive to:
the first input receiving the first signal, and
the second input receiving the second signal.

2. The device of claim 1, wherein each of the first input and the second input are configured to receive a high voltage signal or a low voltage signal from the vehicle, and wherein the logic circuit is configured such that the control signal is generated responsive to each of the first signal and the second signal being low voltage signals.

3. The device of claim 2, wherein the logic circuit is configured such that the control signal is a low voltage signal.

4. The device of claim 2, wherein the first signal comprises less than approximately 4 volts, and the second signal comprises less than approximately 4 volts, and the first input is configured to receive the voltage of the first signal, and the second input is configured to receive the voltage of the second signal.

5. The device of claim 1, wherein the vehicle includes a second manually operable user input device operable to cause generating a third signal, and wherein the control device includes a third input configured to receive the third signal, and the logic circuit being configured to operate the non-mechanical electronic switch to provide the control signal to the output responsive to:
the first input receiving the first signal,
the second input receiving the second signal, and
the third input receiving the third signal.

6. The device of claim 5, wherein each of the first input, the second input, and the third input are configured to receive a high voltage signal or a low voltage signal from the vehicle, and wherein the logic circuit is configured such that the control signal is generated responsive to each of the first signal and the second signal being low voltage signals and the third signal being a high voltage signal.

7. The device of claim 5, wherein the third signal comprises between approximately 5 and 12 volts, and the third input is configured to receive the voltage of the third signal.

8. The device of claim 1, wherein the logic circuit includes at least one logic gate, the, or each, logic gate being associated with at least two of the inputs.

9. The device of claim 8, wherein the logic circuit includes at least two logic gates, and wherein one of the logic gates is associated with one of the inputs and an output of another logic gate.

10. The device of claim 1, wherein the logic circuit includes a microcontroller, the microcontroller configured to operate the non-mechanical electronic switch responsive to receiving the first signal and the second signal.

11. The device of claim 1, wherein the non-mechanical electronic switch includes a metal-oxide-semiconductor field-effect transistor.

12. The device of claim 1, further comprising a power input.

13. The device of claim 12, wherein the vehicle comprises an accessories circuit, and wherein the power input is connectable to the accessories circuit.

14. The device of claim 12, wherein the power input is configured to receive a 12-volt signal.

15. The device of claim 1, wherein the control signal generated by the non-mechanical electronic switch powers the auxiliary light.

16. The device of claim 1, wherein the vehicle comprises headlamps operable to illuminate in a headlamp on mode and a high beam mode, and the first manually operable user input device is configured as a headlamp stalk for controlling operation of the headlamps, wherein operating the stalk causes generating the first signal as a headlamp on signal, and generating the second signal as a high beam on signal, and wherein the first input is configured to receive the headlamp on signal, and the second input is configured to receive the high beam on signal.

17. The device of claim 5, wherein the second manually operable user input device is configured as an automatic high beam (AHB) mode switch, wherein operating the switch causes generating the third signal as an AHB off signal, and the third input is configured to receive the AHB off signal.

18. The device of claim 1, wherein the auxiliary light comprises a driving light mounted to the vehicle, and wherein the output is configured to operably couple to the driving light to provide the control signal and cause the driving light to illuminate.

19. A vehicle including the device of claim 1.

20. A kit comprising an auxiliary light and the device of claim 1.
